(19) United States
(12) Patent Application Publication
(10) Pub. No.: US 2008/0029194 A1
(43) Pub. Date: Feb. 7, 2008

(54) Pressure control system

(76) Inventor: Joseph P. Conroy, Brunswick, OH (US)

Correspondence Address: KRIEG DEVAULT LLP, ONE INDIANA SQUARE, SUITE 2800, INDIANAPOLIS, IN, 46204-2079, US

(21) Appl. No.: 11/498,702

(22) Filed: Aug. 2, 2006

(51) Int. Cl. B60C 29/00

(52) U.S. Cl. 152/415

(57) ABSTRACT

A pressure control includes a body, a fitting, a valve, and a tube. The body has a first opening, second opening, and passage connecting the first and second openings. The body is secured to an axle. A tire containing pressurized gas is mounted on the wheel. The fitting is mounted on the wheel. The fitting has a proximal end and a distal end and includes a passage therethrough. The proximal end of the fitting is in communication with the gas in the tire. The valve is secured to the body. The tube extends between the fitting and body and is retained within the fitting. The gas inside the tire passes through the coupling and tube to the valve. The valve releases the gas to the atmosphere when the gas is above a predetermined pressure.

### BACKGROUND

The present invention relates generally to pressure control systems, and more particularly, but not exclusively to pneumatic pressure control systems in tires rotated at high speeds.

During high speed operation of gas filled tires, such as a race car tire mounted on a wheel, the gas inside the tire heats up and expands. The gas in the tire is typically air or nitrogen (hereinafter referred to as “air” or “gas”). Tire pressure may increase to such an extent that operation and/or safety may be adversely affected. Air bleeder valves have been used to limit pressure in a tire by allowing air to escape at pressures above a predetermined level. One example of this is shown in U.S. Pat. No. 5,954,084 issued to Conroy, Sr., which is hereby incorporated by reference. Bleeder valves may be installed in a body that is attached to an axle. A tube connects the bleeder to a coupling on the wheel that is in fluid communication with the gas inside the tire. The coupling includes a fitting that engages the tube.

A problem arises where dirt, rocks, mud, and other debris strike and damage the coupler coupling the tube to the fitting. The damaged coupler may allow the gas inside the tire to leak uncontrollably to the atmosphere causing the tire to lose pressure. The loss in pressure will cause the tire to go flat and upset the balance of the car. A second problem arises where contaminants are allowed to contact the bleeders. Contaminants present in the bleeders may cause the bleeders to cease functioning properly and allow too much or not enough gas to pass to the atmosphere. The gain/loss of pressure will cause the tire to increase/decrease in size and upset the balance of the car.

Thus, a need exists for a pneumatic pressure control system that eliminates pressure loss due to damaged couplers and prevents contaminants from entering the pneumatic pressure control system.

### SUMMARY

The pressure control system includes a body connected to an axle of a vehicle, a fitting coupled to the wheel, a pressure relief valve connected to the body, and a tube extending between the fitting and the body. The wheel has a tire mounted thereon that is inflated with gas. The fitting is in communication with the gas in the tire and includes a first end cap with a screen and a second end cap that prevent contaminants from entering the pressure control system, and a coupler therein to retain the tube within the fitting. The fitting allows the gas to pass through the coupling and the tube to the valve where the gas is released to the atmosphere above a predetermined pressure.

Further embodiments, forms, features, aspects, benefits, and advantages of the present application shall become apparent from the description and figures provided herewith.

### BRIEF DESCRIPTION OF THE DRAWINGS

FIG. 1 is a schematic view of a vehicle with a pressure control system coupled to the wheel.

FIG. 2 is a side plan view of the pressure control system according to one embodiment of the current invention.

FIG. 3 is an exploded sectional view of the fitting according to one embodiment of the current invention.

FIG. 4 is an assembled sectional view of the fitting shown in FIG. 3.

### DETAILED DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

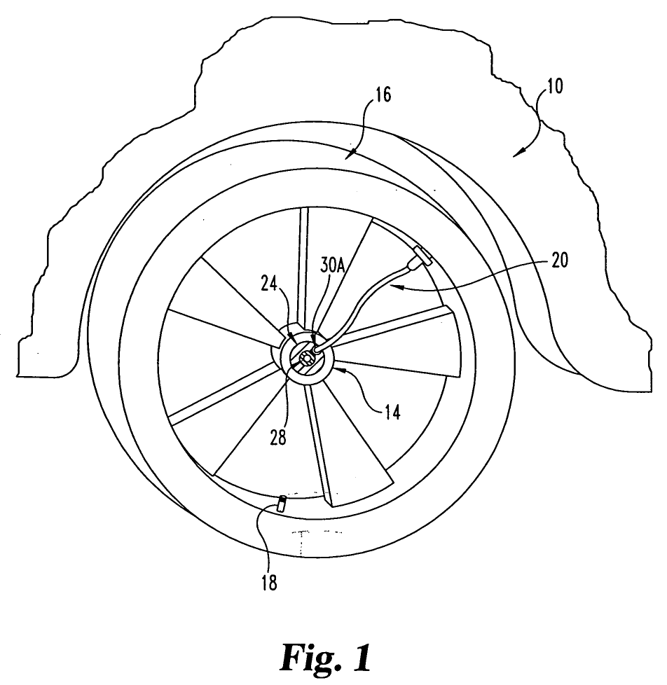

Referring now to the drawings, FIG. 1 illustrates a vehicle 10 having a wheel 12 that rotatably engages an axle 14. The wheel 12 has a tire 16 mounted thereon that may be inflated with pressurized gas such as air and nitrogen. The pressurized gas may enter the tire 16 by way of a valve stem 18. The pressurized gas may form an air tight seal between the wheel 12 and the tire 16. A tire pressure control system 20 is coupled to the wheel 12 to release the pressurized gases when the pressurized gas is above a predetermined pressure. The predetermined pressure may be changed by the user to accommodate for environmental variables and/or different applications of the device.

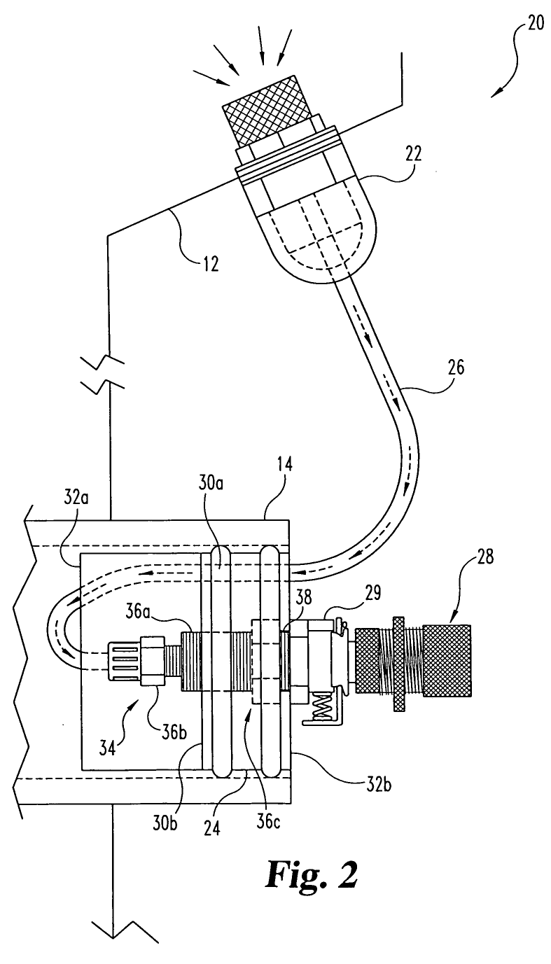

FIG. 2 illustrates the pressure control system 20 according to one embodiment of the current invention. The pressure control system 20 may include a fitting 22, a billet 24, a tube 26 that extends between the fitting 22 and the billet 24, and an air bleeder 28. The fitting 22 is coupled to the wheel 12. A proximal end of the fitting 22 is in communication with the pressurized gas inflating the tire 16. The fitting 22 may be coupled to the wheel 12 approximately 180° away from the valve stem 18. This arrangement allows the user to hear if gas that is leaking from the fitting 22 while inflating the tire 16.

The billet 24 may be coupled to the axle 14 of the vehicle 10. The billet 24 may be cylindrically shaped and include a first passage 30a, a second passage 30b, a proximal end 32a, and a distal end 32b. The first passage 30a extends between the proximal and distal ends 32a and 32b of the billet 24 and may be offset from the center of the billet 24. The first passage 30a may allow the tube 26 to pass through the billet 24. The second passage 30b extends between the proximal and distal ends 32a and 32b of the billet 24 and may be aligned concentrically with the billet 24. The second passage 30b may contain a portion of a coupler 34 therein. The billet 24 may be composed of aluminum, other rigid metals, polymers, or various other materials.

The tube 26 may be a flexible tube that extends between a distal end of the fitting 22 and the coupler 34. One end of the tube 26 may be coupled within the distal end of the fitting 22, while the other end of the tube 26 may be routed through the first passage 30a of the billet 24 and removably coupled to a coupler 34 within the second passage 30b of the billet 24. The tube 26 may be a 5/32 inch flexible tube composed of Nylon, but may have different sizes and/or be composed of other flexible or rigid materials such as plastic, rubber, or metal for example.

The coupler 34 includes a base 36a and a connector 36b. A portion of the coupler 34 is retained within the second passage 30b by a fastener 36c that engages the distal end 32b of the billet 24. The connector 36b may removably interlock with a portion of the base 36a located within the second passage 30b to secure the end of the tube 26 to the base 36a of the coupler 34. In one embodiment, the coupler 34 is a Delrin Acetal Thermoplastic Quick Coupling FT-PMC.

The air bleeder 28 may be directly coupled to a portion of the base 36a, opposite the tube 26, that may extend through an opening 38 in the distal end 32b. An air bleeder fitting 29 may be connected between the base 36a and the air bleeder 28. The air bleeder fitting 29 may engage the coupler 34 or may be the coupler 34. The air bleeder fitting 29 allows pneumatic connection of the air bleeder 28 and the coupler 34. In one embodiment, the air bleeder fitting 29 may be a Colder Products Company PMCD 12-025 Delron fitting. The air bleeder 28 may be operable to allow the user to set a threshold pressure above which the gasses communicated from the tire 16 through the fitting 22 and the tube 26 will be released to the atmosphere. When the air inside the tire 16 begins to heat up, thereby causing an increase in tire pressure, the air bleeder 28 relieves air to maintain the tire pressure at a predefined pressure level.

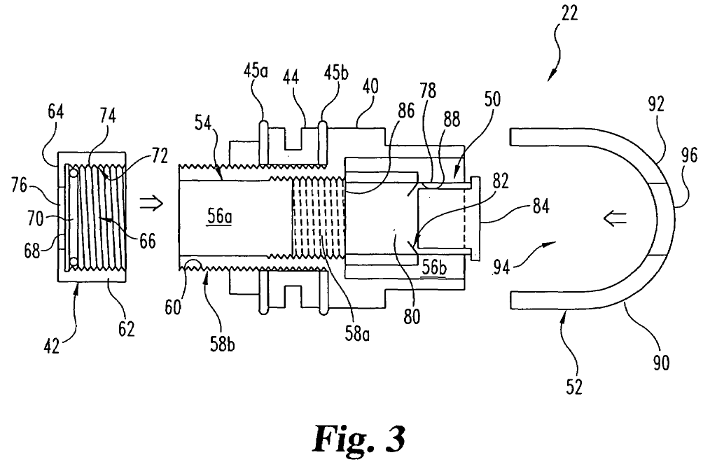

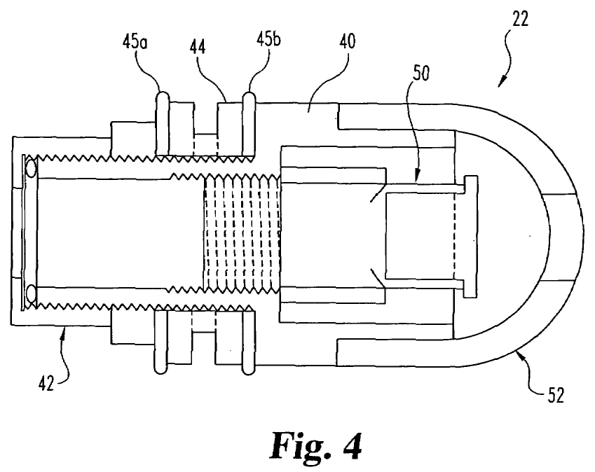

FIGS. 3 and 4 illustrate cross-sectional views of the fitting 22 utilized in the pressure control system 20. The fitting 22 may include a fitting body 40, a first end cap 42 attached to the proximal end of the fitting body 40, a seal 44 mounted on the proximal end of the fitting body 40 with spacers 45a and 45b located on each side of the seal 44, a coupler 50, and a second end cap 52 attached to the distal end of the fitting body 40. The seal 44 may be a grommet and the spacers 45a and 45b may be washers. The fitting body 40 includes a fitting passage 54 therethrough having a proximal portion 56a and a distal portion 56b. The maximum dimension of the distal portion 56b of the fitting passage 54 may be greater than the maximum dimension of the proximal portion 56a of the fitting passage 54. Internal threads 58a may be disposed about a portion of the proximal portion 56a of the fitting passage 54 where the proximal portion 56a and the distal portion 56b intersect. External threads 58b may be disposed about the outer surface 60 of the proximal end of the fitting body 40. The fitting body 40 may be composed of 6061-T6 aluminum, or other rigid or semi-rigid materials such as plastic, steel, rubber, and carbon-fiber for example.

The first end cap 42 may include a cap body 62 having a top 64 and a cap passage 66 running through a portion of the cap body 62, a screen 68, and a seal 70. The cap body 62 is generally cylindrical in shape and may be composed of aluminum. The cap body 62 may include threads 72 located on a portion of the inner surface 74. The threads 72 are operable to engage the external threads 58b of the fitting body 40 to secure the first end cap 42 to the fitting body 40. The top 64 may include an aperture 76 that may be aligned concentrically with the cap body 62 and cap passage 66. The maximum dimension of the top 64 may be greater than the maximum dimension of the aperture 76. The screen 68 may be located within the cap body 62 adjacent the top 64 and opening 76. It should be apparent that the screen 68 may alternatively be retained within the fitting body 40. The screen 68 may be circular in shape and may be positioned within the cap body 62 between the top 64 and the seal 70. The screen 68 may alternatively be retained against the top 64 by threadedly engaging the threads 72, a retaining clip, a fastener, a snap ring, o-ring, or other suitable retainers. The screen 68 prevents dirt, rust, tire particulates, and other contaminants that may be present in the tire 16 from being communicated to the air bleeder 28 where they may cause the air bleeder 28 to malfunction. As previously set forth, a malfunctioning air bleeder 28 may upset the balance of the vehicle due to unwanted increases or decreases in the pressure of the gasses within the tire 16.

The coupler 50 may include a coupler body 78 having a coupler passage 80 therethrough, retaining fingers 82 disposed within the coupler passage 80, and a push release button 84. The coupler body 78 may be cylindrical in shape and composed of aluminum. The coupler 50 may be a Pisco #PSC4-01M. The proximal end of the coupler body 78 may include threads 86 that engage internal threads 58a of the fitting body 40 to secure the coupler 50 within the distal portion 56b of the fitting passage 54. The retaining fingers 82 are attached to the inner surface 88 of the coupler passage 80 and are angled such that when the tube 26 is inserted into the coupler passage 80, the fingers 82 are depressed by the tube 26 and slidingly engage the outer surface of the tube 26. When force is applied to the tube 26 that would otherwise pull the tube 26 out of the coupler passage 80, the movement of the outer surface of the tube 26 causes the fingers 82 to engage the tube 26 to retain it within the coupler passage 80.

The push release button 84 may be located at the distal end of the coupler body 78 and may be slidably retained within the coupler passage 80. In order to release the tube 26 from the fingers 82, the push release button 84 must be pressed toward the proximal end of the coupling body 78 thereby disengaging the fingers 82 from the outer surface of the tube 26. Upon disengagement of the fingers 82 from the outer surface of the tube 26, the tube 26 may be removed from the fitting 22.

The second end cap 52 may be frictionally retained on the distal end of the fitting body 40. In other embodiments, the second end cap 52 may engage the distal end of the fitting body 40 by mechanical interlock or threaded engagement. The second end cap 52 may include a cap body 90 having a top portion 92 and an aperture 94. The body 90 may be generally cylindrical and may be composed of rubber, plastic silicon, or other semi-rigid or rigid materials. The top portion 92 includes an aperture 96 therein that allows the tube 26 to pass through the cap body 90 and engage the coupler 50. The opening 96 may sealingly engage the tube 26 to prevent contaminants from reaching the coupler 50 and the tube 26 when the second end cap 52 is engaged with the distal end of the fitting body 40. Contamination of the coupler 50 and/or tube 26 may cause the coupler 50 to malfunction such that the tube 26, when inserted, does not fully engage the fingers 82, which may allow the tube 26 to become disconnected from the fitting 22 during operation thereby allowing pressurized gases to escape to the atmosphere. In addition, contamination of the coupler 50 and/or tube 26 may be communicated to the valve 28 and cause the valve 28 to malfunction.

In operation, the tire 16 is mounted on the wheel 12 and inflated with pressurized gases. The wheel 12 may then be mounted on the axle 14 of the vehicle 10 and rotated with respect to the axle 14. When the wheel 12 is rotated at high speeds, friction between the tire 16 and surface engaged by tire 16 generates heat that causes the pressurized gas within the tire 16 to expand. The pressurized gas is released to the atmosphere by the pressure control system 20 upon reaching a predetermined pressure.

The pressurized gas enters the pressure control system 20 through the fitting 22 mounted on the wheel 12. The gas passes through a screen 68 that blocks contaminants from entering the pressure control system 20. The tube 26 may be inserted into the coupler 50 positioned within the distal portion 56b of the fitting passage 54 and retained therein by fingers 82 to directly couple the tube 26 within the fitting 22. The tube 26 may communicate the pressurized gas from the fitting 22 to the coupler 34. The tube 26 may pass through first passage 30a of the billet 24 and may be removably coupled to the one end of the base 36a of the coupler 34. A portion of the base 36a may extend through the opening 38 in the distal end 32b of the billet 24 and couple with the air bleeder 28. The air bleeder 28 releases the pressurized gas to the atmosphere once the pressurized gas reaches a predetermined pressure level.

While the invention has been illustrated and described in detail in the drawings and foregoing description, the same is to be considered illustrative and not restrictive in character, it being understood that only selected embodiments have been shown and described and that all changes, equivalents, and modifications that come within the scope of the inventions described herein or defined by the following claims are desired to be protected. Any experiments, experimental examples, or experimental results provided herein are intended to be illustrative of the present invention and should not be construed to limit or restrict the invention scope. Further, any theory, mechanism of operation, proof, or finding stated herein is meant to further enhance understanding of the present invention and is not intended to limit the present invention in any way to such theory, mechanism of operation, proof, or finding. In reading the claims, words such as “a”, “an”, “at least on”, and “at least a portion” are not intended to limit the claims to only one item unless specifically stated to the contrary. Further, when the language “at least a portion” and/or “a portion” is used, the claims may include a portion and/or the entire item unless specifically stated to the contrary.

What is claimed is:

1. A pressure control system comprising:
a body being secured to an axle of a vehicle;
a fitting including a passage therethough and being secured to a wheel, said fitting having a proximal end and a distal end, said proximal end of said fitting being in communication with a gas in a tire mounted on said wheel;
a valve being secured to said body; and
a tube extending between a distal end of said fitting and said body, said tube being retained within said distal end of said fitting, said gas inside said tire passing through said fitting and said tube to said valve, said valve releasing said gas to the atmosphere when said gas is above a predetermined pressure.

2. The system of claim 1, wherein said fitting further includes a screen.

3. The system of claim 2, wherein said fitting further includes an end cap engaging said proximal end of said fitting, said screen being retained within said end cap.

4. The system of claim 1, wherein said fitting further includes an end cap, said end cap having a passage therethrough and engaging said distal end of said fitting.

5. The system of claim 1, wherein said fitting further includes a coupler positioned substantially within said distal end of said fitting, said coupler includes at least one engaging member and a release member, said at least one engaging member engaging said outer surface of said tube to retain said tube within said distal end of said fitting, said release member being slidedly retained within said coupling and being urged against said at least one engaging member to disengage said at least one engaging member from said outer surface of said tube.

6. The system of claim 1, wherein said tube is composed of nylon.

7. A pressure control system comprising:
a body being secured to an axle of a vehicle;
a fitting being secured to said wheel, said fitting having a proximal end and a distal end, said fitting including a passage therethough, a first end cap engaging said proximal end, and a screen retained within said first end cap, said proximal end of said fitting being in communication with said gas in said tire;
a valve being secured to said body; and
a tube extending between a distal end of said fitting and said body, said gas inside said tire passing through said fitting and said tube to said valve, said valve releasing the gas to the atmosphere when said gas is above a predetermined pressure.

8. The system of claim 7, wherein said screen is retained within said first end cap by a retaining means.

9. The system of claim 7, wherein said screen engages said first end cap to retain said screen within said first end cap.

10. The system of claim 7, wherein said fitting further includes a second end cap, said second end cap having a passage therethrough and engaging said distal end of said fitting.

11. The system of claim 7, wherein said fitting further includes a coupler positioned substantially within said distal end of said fitting.

12. The system of claim 11, wherein said coupler includes at least one engaging member and a release member, said engaging member being positioned within said coupler and engaging said outer surface of said tube to retain said tube within said distal end of said fitting, said release member being slidedly retained within said coupler and being urged against said at least one engageing member to disengage said at least one engaging member from said outer surface of said tube.

13. The system of claim 7, wherein said tube is directly coupled within said distal end of said fitting,

14. The system of claim 7, wherein said tube is composed of nylon.

15. A pressure control system comprising:
a body being secured to an axle of a vehicle;
a fitting including a passage therethrough and being secured to a wheel of said vehicle, said fitting having a proximal end and a distal end, said fitting including a passage therethough and an end cap engaging said distal end, said proximal end of said fitting being in communication with a gas in a tire mounted on said wheel;
a valve being secured to said body; and
a tube extending between a distal end of said fitting and said body, said gas inside said tire passing through said fitting and said tube to said valve, said valve releasing the gas to the atmosphere when said gas is above a predetermined pressure.

16. The system of claim 15, wherein said fitting further includes a screen.

17. The system of claim 15, wherein said end cap includes a passage therethough, said tube passing through said passage and directly coupling within said distal end of said fitting.

18. The system of claim 15, wherein said fitting further includes a coupler positioned within said distal end of said fitting.

19. The system of claim 18, wherein said coupler includes at least one engagement member and a release member, said engaging member positioned within said coupler and engaging said outer surface of said tube to retaining said tube within said distal end of said fitting, said release member being slidedly retained within said coupler and being urged against said at least one engageing member to disengage said at least one engaging member from said outer surface of said tube.

20. A method of controlling pressure, comprising:
providing a pressure control system including a fitting, a body, a tube extending between said fitting and said body, and a valve;
coupling said body to an axle of a vehicle;
coupling said fitting to a wheel, said fitting having a proximal end and a distal end and including a passage therethrough, said proximal end of said fitting being in communication with a gas in a tire mounted on said wheel;
inserting a first end of said tube into said distal end of said fitting to couple said tube within said fitting;
coupling a second end of said tube to a first opening of said body;
coupling said valve to a second opening of said body, said valve being in communication with said second end of said tube; and
through said valve, releasing said gas to the atmosphere from within said tire once said gas has reached a predetermined pressure.

21. The method of claim 20, wherein said fitting further includes an end cap having a passage therethrough, said second end cap engaging said distal end of said fitting.

22. The method of claim 20, wherein said fitting further includes a screen.

23. The system of claim 20, wherein said fitting further includes a coupler positioned within said distal end of said fitting, said coupler includes at least one engagement member and a release member, said engaging member positioned within said coupler and engaging said outer surface of said tube to retaining said tube within said distal end of said fitting, said release member being slidedly retained within said coupler and being urged against said at least one engageing member to disengage said at least one engaging member from said outer surface of said tube.
